(19) United States
(12) Patent Application Publication
(10) Pub. No.: US 2025/0352936 A1
(43) Pub. Date: Nov. 20, 2025

(54) 3D-TRIPTYCENE-BASED MICROPOROUS POLYMER WITH HYDROXYL GROUPS FOR CARBON DIOXIDE CAPTURE AND METHODS OF PREPARATION THEREOF

(71) Applicant: KING FAHD UNIVERSITY OF PETROLEUM AND MINERALS, Dhahran (SA)

(72) Inventors: Mohd Yusuf KHAN, Dhahran (SA); Mosim ANSARI, Dhahran (SA); Mahmoud Mohamed ABDELNABY, Dhahran (SA)

(73) Assignee: KING FAHD UNIVERSITY OF PETROLEUM AND MINERALS, Dhahran (SA)

(21) Appl. No.: 18/668,928

(22) Filed: May 20, 2024

(51) Int. Cl. B01D 53/02; B01J 20/26; C08G 61/02

(52) U.S. Cl. CPC B01D 53/02; B01J 20/262; C08G 61/02; B01D 2253/202; B01D 2253/304; B01D 2253/306; B01D 2253/311; B01D 2257/504; C08G 2261/312; C08G 2650/64

(57) ABSTRACT

A microporous polymer including reacted units of a triptycene, a secondary carbon linker, and a dihydroxy phenol in the form of porous particles is described. The reacted units of the triptycene are covalently bonded to the dihydroxy phenol by the secondary carbon linker.

### STATEMENT OF ACKNOWLEDGEMENT

Support provided by the Interdisciplinary Research Center for Hydrogen and Energy Storage (IRC-HES), King Fahd University of Petroleum and Minerals, Saudi Arabia is gratefully acknowledged.

### BACKGROUND

### Technical Field

The present disclosure is directed to a 3D-triptycene-based microporous polymer (TBPP-OH) with hydroxyl groups for carbon dioxide (CO₂) capture.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present claims.

Increasing carbon dioxide (CO₂) concentration in the atmosphere is a contributing cause of global warming and climate change. Statistics from 2023 show that the atmospheric CO₂ content is higher than it has ever been in modern history, topping 420 parts per million (ppm), and continues to rise. This corresponds to an approximate 50% rise since the start of the industrial age and an upsurge of around 14% since the year 2000, when the atmospheric CO₂ concentration was already near 370 ppm. CO₂ capture and separation (CCS) is an effective way to reduce the amount of CO₂ in the atmosphere. Industries use a wet scrubbing method with monoethanolamine (MEA) for the chemisorption of CO₂; however, there are drawbacks associated with this process, such as high energy for regeneration, corrosion of equipment due to the corrosive nature of MEA, and low capture capacity. The use of porous solid adsorbents for CO₂ capture is an efficient alternative approach to the wet scrubbing method. The development of porous materials for efficient CO₂ uptake, such as zeolites-based materials, porous carbons, metal-organic frameworks (MOFs), and others, have been explored for this purpose [S. Kumar, R. Srivastava, J. Koh, Utilization of zeolites as CO₂ capturing agents: Advances and future perspectives, Journal of CO₂ Utilization. 41 (2020) 101251; X. Yuan, J. Wang, S. Deng, M. Suvarna, X. Wang, W. Zhang, S. T. Hamilton, A. Alahmed, A. Jamal, A. H. A. Park, X. Bi, Y. S. Ok, Recent advancements in sustainable upcycling of solid waste into porous carbons for carbon dioxide capture, Renewable and Sustainable Energy Reviews. 162 (2022); S. Mahajan, M. Lahtinen, Recent progress in metal-organic frameworks (MOFs) for CO₂ capture at different pressures, J Environ Chem Eng. 10 (2022); G. Singh, J. Lee, A. Karakoti, R. Bahadur, J. Yi, D. Zhao, K. Albahily, A. Vinu, Emerging trends in porous materials for CO₂ capture and conversion, Chem Soc Rev. 49 (2020)]; however, as time required, a new class of porous materials called porous organic polymers (POP), which have a large specific surface area and a persistent pore structure, emerged as a porous material for CO₂ capture. Due to their high porosity, design flexibility, large specific surface area, low density, and physiochemical stability, POPs have potential for usage in a variety of processes, such as energy storage, catalysis, and gas capture and separation. Moreover, the synthesis of POPs is relatively facile compared to that of inorganic microporous materials and metal-organic frameworks (MOFs).

Although several materials have been developed in the past for CO₂ capture, there still exists a need to fabricate and explore more efficient POPs-based materials for efficient and selective CO₂ capture. Accordingly, an object of the present disclosure is to develop a three-dimensional triptycene-based microporous polymer with hydroxyl groups for carbon dioxide capture that overcomes the limitations of known CO₂ capture.

### SUMMARY

In an exemplary embodiment, a microporous polymer is described. The microporous polymer includes reacted units of a triptycene, a secondary carbon linker, and a dihydroxy phenol.

The microporous polymer is in the form of porous particles. The reacted units of the triptycene are covalently bonded to the dihydroxy phenol by the secondary carbon linker.

In some embodiments, a method for capturing CO₂, comprises contacting a CO₂-containing gas stream with the porous particles of the microporous polymer of claim 1 to trap molecules of CO₂ in the CO₂-containing gas stream in the molecular structure of the microporous polymer. The microporous polymer includes reacted units of triptycene, reacted units of dimethoxymethane, and resorcinol.

In some embodiments, the microporous polymer contains oxygen in an amount 20 to 30 atomic percent (at. %) based on a total atomic count of the microporous polymer.

In some embodiments, the microporous polymer has a thermal degradation temperature of 350 to 400 degrees Celsius (° C.), wherein the thermal degradation temperature is determined at a weight loss of 10 wt. % based on an initial weight of the microporous polymer.

In some embodiments, the microporous polymer has a char yield at 800° C. of 55 to 65 wt. % based on an initial weight of the microporous polymer.

In some embodiments, the porous particles are in the form of spheres with a diameter of 0.2 to 2 micrometers (μm).

In some embodiments, the spheres are aggregated.

In some embodiments, the porous particles have a Brunauer-Emmett-Teller (BET) surface area of 800 to 850 square meters per gram (m² g⁻¹).

In some embodiments, the porous particles have a total pore volume of 0.400 to 0.600 cubic centimeters per gram (cm³ g⁻¹).

In some embodiments, the porous particles have a micropore volume of 0.300 to 0.400 cm³g⁻¹.

In some embodiments, porous particles have a micropore volume of 65 to 75 percent (%).

In some embodiments, the microporous polymer has a carbon dioxide (CO₂) isosteric heat of adsorption (Qₛₜ) of 30 to 35 kilojoules per mole (kJ mol⁻¹).

In some embodiments, the microporous polymer has a CO₂ uptake of 120 to 125 milligrams per gram (mg g⁻¹) at a pressure of 1 bar and a temperature of 273 kelvin (K).

In some embodiments, the microporous polymer has a CO₂ uptake of 75 to 80 mg g⁻¹ at a pressure of 1 bar and a temperature of 298 K.

In some embodiments, the microporous polymer has a CO₂ uptake of 50 to 60 mg g⁻¹ at a pressure of 1 bar and a temperature of 313 K.

In some embodiments, microporous polymer has a methane (CH₄) uptake of 10 to 15 mg g⁻¹ at a pressure of 1 bar and a temperature of 273 K.

In some embodiments, microporous polymer has a CH₄ uptake of 5 to 10 mg g⁻¹ at a pressure of 1 bar and a temperature of 298 K.

In some embodiments, the microporous polymer has a selectivity of CO₂/N₂ from 35 to 40 at a temperature of 273 K.

In some embodiments, the microporous polymer has a selectivity of CO₂/CH₂ from 3 to 5 at a temperature of 273 K.

In some embodiments, a method of making a microporous polymer is described. The method includes mixing triptycene, resorcinol, dimethoxymethane, and an iron salt in an organic solvent to form a solution. A molar ratio of the triptycene to the resorcinol is 1:2 to 2:1. A molar ratio of the triptycene to the dimethoxymethane is 1:1 to 1:5. A molar ratio of the triptycene to the iron salt is 1:2 to 1:6. The method further includes refluxing the solution for 18 to 30 hours (h) to form a solid, washing and drying the solid, refluxing the solid with an alcohol, and drying the solid at 100 to 120° C. for 18 to 30 h to form the polymer.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternative and/or variations thereof) and many of the attendant advantages thereof may be readily obtained as the same becomes better understood by reference to the following detailed description when considered in connection with the accompanying drawings, wherein:

FIG. 1A is a flow chart depicting a method for making a 3D-triptycene-containing microporous polymer (TBPP-OH), according to certain embodiments;

FIG. 1B is a schematic representation for the synthesis of the TBPP-OH, according to certain embodiments;

FIG. 2 shows Fourier-transform infrared (FTIR) spectra of TBPP-OH, triptycene, and resorcinol according to certain embodiments;

FIG. 3 shows a solid-state carbon-13 (¹³C) cross-polarization magic-angle-spinning nuclear magnetic resonance (¹³C CP-MAS NMR) spectra of the TBPP-OH, according to certain embodiments;

FIG. 4 shows a powder X-ray diffraction (PXRD) pattern of the TBPP-OH, according to certain embodiments;

FIG. 5 shows a thermogravimetric analysis (TGA) analysis of the TBPP-OH, according to certain embodiments;

FIG. 6A depicts a field-emission scanning electron microscopy (FESEM) image of the TBPP-OH at a 20 kx magnification, according to certain embodiments;

FIG. 6B depicts an FESEM image of the TBPP-OH at a 50 kx magnification, according to certain embodiments;

FIG. 6C depicts an FESEM image of the TBPP-OH at a 100 kx magnification, according to certain embodiments;

FIG. 6D is an energy-dispersive X-ray spectroscopy (EDS) spectrum of the TBPP-OH, according to certain embodiments;

FIG. 6E is an EDS-elemental mapping image of the TBPP-OH showing carbon (C), according to certain embodiments;

FIG. 6F is an EDS-elemental mapping image of the TBPP-OH showing oxygen (O), according to certain embodiments;

FIG. 7A is a nitrogen (N₂) sorption isotherm at 77 kelvin (K) for the TBPP-OH, according to certain embodiments;

FIG. 7B is a pore size distribution plot for TBPP-OH, according to certain embodiments;

FIG. 8A shows carbon dioxide (CO₂) adsorption-desorption isotherms at different temperatures for the TBPP-OH, according to certain embodiments;

FIG. 8B is a graph showing the heat of adsorption for the TBPP-OH, according to certain embodiments;

FIG. 9A shows CO₂, methane (CH₄), and nitrogen (N₂) isotherms for the TBPP-OH at 273 K, according to certain embodiments;

FIG. 9B shows CO₂, CH₄, and N₂ isotherms for the TBPP-OH at 298 K, according to certain embodiments; and

FIG. 10 shows ideal adsorbed solution theory (IAST) selectivity curves for the TBPP-OH with 15% CO₂: 85% N₂ and 50% CO₂: 50% CH₄ compositions at 273 K and 298 K, according to certain embodiments.

### DETAILED DESCRIPTION

In the following description, it is understood that other embodiments may be utilized, and structural and operational changes may be made without departure from the scope of the present embodiments disclosed herein.

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

Reference will now be made to specific embodiments or features, examples of which are illustrated in the accompanying drawings. In the drawings, whenever possible, corresponding or similar reference numerals will be used to designate identical or corresponding parts throughout the several views. Moreover, references to various elements described herein are made collectively or individually when there may be more than one element of the same type. However, such references are merely exemplary in nature. It may be noted that any references to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “porosity” refers to a measure of the void (empty) or vacant spaces within a material. Porosity may be presented as a fraction of the volume of voids over the total volume with a value between 0 and 1 or as a percentage between 0% and 100%. As used herein, the terms “particle size” and “pore size” may be thought of as the lengths and/or longest dimensions of a particle and of a pore opening, respectively.

As used herein, “micropores” refer to pores with a diameter of less than or equal to 2 nanometers (nm) and “microporosity” refers to a material having pores with a diameter of less than or equal to 2 nm. As used herein, “mesopores” refer to pores with a diameter of 2 to 50 nm and “macropores” refer to pores with a diameter of greater than or equal to 50 nm.

As used herein, the term “deionized water” refers to water that has (most of) the ions removed. As used herein, the deionized water may have at least 95%, at least 96%, at least 97%, at least 98%, at least 99%, at least 99.5%, at least 99.9%, and 100% of the ions removed, based on a total ion count in the water.

A weight percent (wt. %) of a component, unless specifically stated to the contrary, is based on the total weight of the formulation or composition in which the component is included. For example, if a particular element or component in a composition or article is said to have 5 wt. %, it is understood that this percentage is in relation to a total compositional weight percentage of 100%.

The present disclosure is intended to include all hydration states of a given compound or formula, unless otherwise noted or when heating a material.

The present disclosure is intended to include all isotopes of a given compound or formula, unless otherwise noted.

Aspects of the present disclosure are directed to the synthesis of efficient porous polymers with ample microporosity and polar functionalities for enhanced and selective CO₂ capture applications. The incorporation of 3D triptycene motifs in the polymeric framework of the microporous polymer provides desirable properties such as microporosity, high surface area, and thermal stability.

A microporous polymer including reacted units of a triptycene, a secondary carbon linker, and a dihydroxy phenol is described. Triptycene is a molecular unit with three blades or paddles, each composed of a benzene ring. Its rigid, three-dimensional framework makes it an intriguing building block for various applications. Triptycene is a distinctive three-dimensional molecule with three arene rings oriented in a paddle wheel fashion. Internal free volume (IFV) and excellent thermal stability are known characteristics of the unique rigid and sturdy structure of triptycene. Materials containing triptycene has been used for sensing, electronics, liquid crystal displays, gas capture and separation, host-guest chemistry, and molecular machines.

The microporous polymer further includes a secondary carbon linker. Suitable examples of secondary carbon linkers include dialkoxyalkanes such as dimethoxymethane, diethoxymethane, ethoxymethoxymethane, and the like, and a combination thereof. In some embodiments, the secondary carbon linker is dimethoxymethane. In one embodiment, the secondary carbon linker is reacted units of dimethoxymethane, i.e., a methyl group. The microporous polymer further includes a dihydroxy phenol. Suitable examples of dihydroxy phenols include catechol, resorcinol, hydroquinone, and the like, and a combination thereof. In a preferred embodiment, the dihydroxy phenol is resorcinol. In a preferred embodiment, the microporous polymer includes reacted units of triptycene, reacted units of dimethoxymethane, and resorcinol.

In some embodiments, a method for capturing CO₂ is described. The method comprises contacting a CO₂-containing gas stream with the porous particles of the microporous polymer to trap molecules of CO₂ in the CO₂-containing gas stream in the molecular structure of the microporous polymer. In some embodiments, the CO₂-containing gas stream may contain one or more gases including, but not limited to, H₂, He, CO, CO₂, CH₄, N₂, O₂, F₂, Cl₂, Br₂, I₂, Ne, Ar, Kr, Xe, and the like, and/or combinations thereof. In some embodiments molecules of CO₂ in the CO₂-containing gas stream may be trapped in the molecular structure of the microporous polymer by size-exclusion principles, Van der Waals forces, and the like.

In some embodiments, the 3D-triptycene containing microporous polymer (TBPP-OH) is in the form of porous particles. In some embodiments, the 3D-triptycene containing microporous polymer, TBPP-OH, is porous, i.e., containing pores. In some embodiments, the 3D-triptycene containing microporous polymer forms a macrostructure, such as a particle, and the macrostructure is porous, i.e., porous particles. Pores may be micropores, mesopores, macropores, and/or a combination thereof. In a preferred embodiment, porous particles have micropores. In some embodiments, the porous particles have a Brunauer-Emmett-Teller (BET) surface area (SABET) of 750-950 square meters per gram (m² g⁻¹), preferably 800-900 m² g⁻¹, preferably 810-845 m² g⁻¹, more preferably 820-840 m² g⁻¹, and yet more preferably about 838 m² g⁻¹. In a preferred embodiment, the porous particles have an SA_{BET} of 883 m² g⁻¹.

In some embodiments, the porous particles have a total pore volume of 0.4-0.6 cubic centimeters per gram (cm³ g⁻¹), preferably 0.41-0.59 cm³ g⁻¹, preferably 0.42-0.58 cm³ g⁻¹, preferably 0.43-0.57 cm³ g⁻¹, preferably 0.44-0.56 cm³ g⁻¹, preferably 0.45-0.55 cm³ g⁻¹, preferably 0.46-0.54 cm³ g⁻¹, preferably 0.47-0.53 cm³ g⁻¹, more preferably 0.48-0.52 cm³ g⁻¹, and yet more preferably 0.49-0.51 cm³ g⁻¹. In a preferred embodiment, the porous particles have a total pore volume of about 0.491 cm³ g⁻¹. In some embodiments, the porous particles have a micropore volume of 0.3-0.4 cm³ g⁻¹, preferably 0.31-0.39 cm³ g⁻¹, preferably 0.32-0.38 cm³ g⁻¹, more preferably 0.33-0.37 cm³ g⁻¹, and yet more preferably 0.34-0.36 cm³ g⁻¹. In a preferred embodiment, the porous particles have a micropore volume of about 0.346 cm³ g⁻¹. The porous particles have a micropore volume of 65-75 percent (%), preferably 66-74%, preferably 67-73%, more preferably 68-72%, and yet more preferably 69-71% based on the total pore volume of the porous particles. In a preferred embodiment, the porous particles have a micropore volume of about 70% based on the total pore volume of the porous particles.

In some embodiments, the porous particles may exist in various morphological shapes, such as rods, spheres, wires, crystals, rectangles, triangles, pentagons, hexagons, prisms, pyramids, disks, cubes, ribbons, blocks, beads, toroids, discs, barrels, granules, whiskers, flakes, foils, powders, boxes, stars, tetrapods, belts, flowers, and the like, and mixtures thereof. In a preferred embodiment, the porous particles are in the form of spheres with a diameter of 0.2-2 micrometers (μm), preferably 0.3-1.9 μm, preferably 0.4-1.8 μm, preferably 0.5-1.7 μm, preferably 0.6-1.6 μm, preferably 0.7-1.5 μm, preferably 0.8-1.4 μm, preferably 0.9-1.3 μm, and preferably 1.0-1.2 μm. In some embodiments, the spheres are aggregated. In some embodiments, the aggregated spheres may be in groups and/or bunches of 2 to 200 spheres, preferably 5 to 175 spheres, preferably 10 to 150 spheres, preferably 25 to 125 spheres, and preferably 50 to 100 spheres. In some embodiments, the spheres may be singular.

In some embodiments, the microporous polymer TBPP-OH contains oxygen in an amount of 20-30 atomic percent (at. %), preferably 21-29 at. %, preferably 22-28 at. %, more preferably 23-27 at. %, and yet more preferably 24-26 at. % based on a total atom count of the microporous polymer. In a preferred embodiment, the microporous polymer contains oxygen in an amount of about 24.77 at. % based on the total number of atoms in the polymer.

In some embodiments, the microporous polymer TBPP-OH has a thermal degradation temperature of 350-400 degrees Celsius (° C.), preferably 355-395° C., preferably 360-390° C., more preferably 365-385° C., and yet more preferably 370-380° C. The thermal degradation temperature is determined at a weight loss of 5-15%, preferably 6-14%, preferably 7-13%, preferably 8-12%, preferably 9-11%, and more preferably about 10% based on an initial weight of the microporous polymer. In a preferred embodiment, the microporous polymer has a thermal degradation temperature of about 372° C. with a weight loss of about 10%.

“Char yield” refers to the residue of a material that remains after being subjected to high-temperature pyrolysis. In thermogravimetric analysis (TGA) of polymers, char yield is determined by heating the sample in an inert gas, such as nitrogen, up to certain temperatures. During this process, the weight loss is monitored. Next, the gas is changed to air, and the temperature continues to rise. The difference in mass between the sample heated in the inert gas and the sample heated in air, divided by the original sample weight, gives the char yield of the polymer. In other words, it represents the solid residue left after the material has been partially decomposed or carbonized. In some embodiments, the microporous polymer has a char yield of 55-65%, preferably 56-64%, preferably 57-63%, more preferably 58-62%, and yet more preferably 59-61% at a temperature of 750-850° C., preferably 760-840° C., preferably 770-830° C., more preferably 780-820° C., and yet more preferably 790-810° C. based on an initial weight of the microporous polymer. In a preferred embodiment, the microporous polymer has a char yield of about 61% by weight at a temperature of about 800° C., based on the initial weight of the microporous polymer.

The isosteric heat of adsorption (Qₛₜ) is a measure of the enthalpy change that occurs when molecules of an adsorbate transition from the gas phase to the adsorbed phase on a solid surface. The isosteric heat of adsorption describes the amount of heat that is released or absorbed during the process of adsorption. In some examples, the microporous polymer has a CO₂ isosteric heat of adsorption of 30-35 kilojoules per mole (kJ mol⁻¹), preferably 31-34 kJ mol⁻¹, and preferably 32-33 KJ mol⁻¹. In a preferred embodiment, the microporous polymer has a CO₂ isosteric heat of adsorption of about 32.9 KJ mol⁻¹.

In some embodiments, the microporous polymer TBPP-OH has a CO₂ uptake of 120-125 milligrams per gram (mg g⁻¹), more preferably 121-124 mg g⁻¹, and yet more preferably 122-123 mg g⁻¹ at a pressure of 1 bar and a temperature of 273 K. In a preferred embodiment, the microporous polymer has a CO₂ uptake of about 122 mg g⁻¹ at a pressure of 1 bar and a temperature of 273 K. In some embodiments, the microporous polymer has a CO₂ uptake of 75-80 mg g⁻¹, more preferably 76-79 mg g⁻¹, and yet more preferably 77-78 mg g⁻¹ at a pressure of 1 bar and a temperature of 298 K. In a preferred embodiment, the microporous polymer has a CO₂ uptake of about 77 mg g⁻¹ at a pressure of 1 bar and a temperature of 298 K. In some embodiments, the microporous polymer has a CO₂ uptake of 50-60 mg g⁻¹, preferably 51-59 mg g⁻¹, preferably 52-58 mg g⁻¹, more preferably 53-57 mg g⁻¹, and yet more preferably 54-56 mg g⁻¹ at a pressure of 1 bar and a temperature of 313 K. In a preferred embodiment, the microporous polymer has a CO₂ uptake of about 56 mg g⁻¹ at a pressure of 1 bar and a temperature of 313 K. The CO₂ uptake exhibited by microporous polymer may be attributed to its highly microporous network formed by 3D triptycene and the presence of CO₂-philic —OH groups.

In some embodiments, the microporous polymer TBPP-OH has a methane (CH₄) uptake of 10-15 mg g⁻¹, more preferably 11-14 mg g⁻¹, and yet more preferably 12-13 mg g⁻¹ at a pressure of 1 bar and a temperature of 273 K. In a preferred embodiment, the microporous polymer has a CH₄ uptake of about 12 mg g⁻¹ at a pressure of 1 bar and a temperature of 273 K. In some embodiments, the microporous polymer has a CH₄ uptake of 5-10 mg g⁻¹, more preferably 6-9 mg g⁻¹, and yet more preferably 7-8 mg g⁻¹ at a pressure of 1 bar and a temperature of 298 K. In a preferred embodiment, the microporous polymer has a CH₄ uptake of about 8 mg g⁻¹ at a pressure of 1 bar and a temperature of 298 K.

In some embodiments, the microporous polymer TBPP-OH has a selectivity of CO₂/N₂ from 35-40, more preferably 36-39, and yet more preferably 37-38 at a temperature of 273 K. In a preferred embodiment, the microporous polymer has a selectivity of about 37 for CO₂/N₂ at a temperature of 273 K. In some embodiments, the microporous polymer has a selectivity of CO₂/CH₂ from 3-5, and preferably about 4 at a temperature of 273 K. In a preferred embodiment, the microporous polymer has a selectivity of about 4.2 for CO₂/CH₂ at a temperature of 273 K.

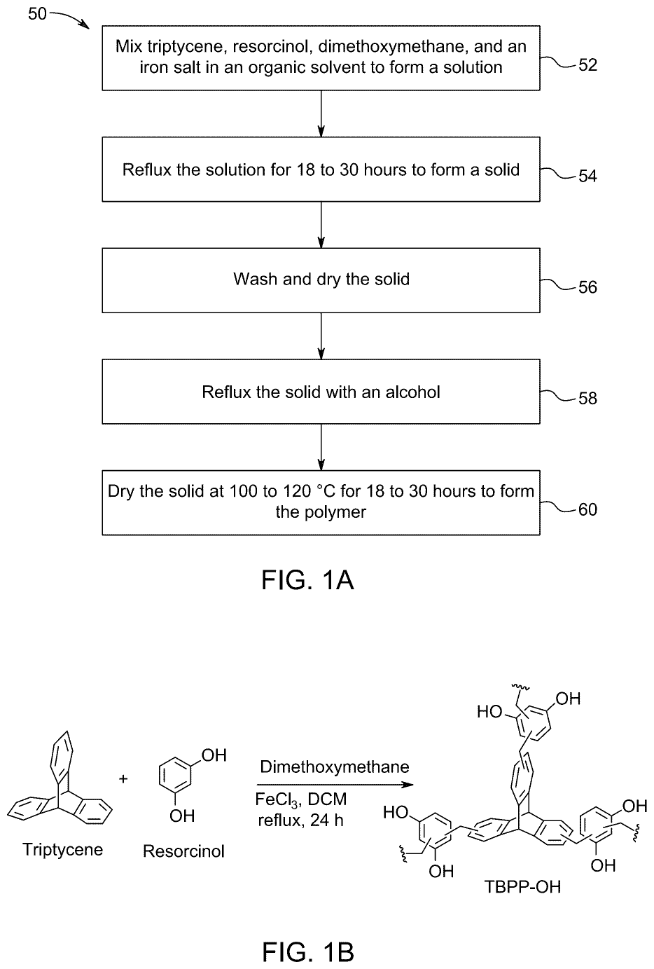

FIG. 1A illustrates a flow chart of a method 50 for making the microporous polymer. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing triptycene, resorcinol, dimethoxymethane, and an iron salt in an organic solvent to form a solution. Suitable examples of iron salts include iron bromide, iron chloride, iron phosphate hydrate, iron phosphate tetrahydrate, iron chloride hydrate, iron chloride tetrahydrate, iron fluoride, ammonium iron sulfate hexahydrate, iron citrate tribasic monohydrate, iron gluconate dehydrate, iron pyrophosphate, iron phthalocyanine, iron phthalocyanine chloride, ammonium iron citrate, ammonium iron sulfate, ammonium iron sulfate hydrate, ammonium iron sulfate dodecahydrate, iron chloride hexahydrate, ferric citrate, iron nitrate nonahydrate, iron oxide, iron phosphate, iron sulfate hydrate, iron gluconate hydrate, iron iodide, iron lactate hydrate, iron oxalate dehydrate, ferrous sulfate heptahydrate, iron sulfide, iron acetate, iron fluoride tetrahydrate, iron iodide tetrahydrate, iron perchlorate hydrate, iron acetylacetonate, iron acetylacetonate hydrate, iron ascorbate, iron ascorbate hydrate, and the like, and/or mixtures thereof. In a preferred embodiment, the iron salt is iron chloride (FeCl₃). An organic solvent is a carbon-based substance employed for the dissolution of other substance(s). Suitable examples of organic solvents include water, methanol, ethanol, acetone, dimethyl sulfoxide (DMSO), dimethylformamide (DMF), dimethylacetamide, isopropanol, benzene, hexane, carbon tetrachloride, toluene, diethyl ether, tetrahydrofuran (THF), dichloromethane (DCM), chloroform, and the like and/or a mixture thereof. In a preferred embodiment, the organic solvent is DCM.

The mixing may be carried out manually or with the help of a stirrer. In some embodiments, a molar ratio of the triptycene to the resorcinol is 1:2 to 2:1, preferably 1.25:1.75 to 1.75:1.25, and more preferably about 1:1. In a preferred embodiment, the molar ratio of the triptycene to the resorcinol is 1:1. In some embodiments, a molar ratio of the triptycene to the dimethoxymethane is 1:1 to 1:5, preferably 1:2 to 1:4, and more preferably 1:3 to 1:3.5. In a preferred embodiment, the molar ratio of the triptycene to the dimethoxymethane is about 1:3. A molar ratio of the triptycene to the iron salt is 1:2 to 1:6, preferably 1:3 to 1:4, and more preferably 1:4 to 1:5. In a preferred embodiment, the molar ratio of the triptycene to the iron salt is about 1:4.

At step 54, the method 50 includes refluxing the solution for 18-30 hours (h), preferably 19-29 h, preferably 20-28 h, preferably 21-27 h, more preferably 22-26 h, and yet more preferably 23-25 h, to form a solid. In a reflux setup, the condenser traps solvent vapors and, as a result, the concentration of reactants remains constant throughout the process. An objective of refluxing a solution is to heat it in a controlled manner at a constant temperature. In a preferred embodiment, the refluxing of the solution is done for about 24 hours to form a solid.

At step 56, the method 50 includes washing and drying the solid. The washing of the solid may be done by using one or more solvents such as water, methanol, ethanol, acetone, DMSO, DMF, dimethylacetamide, isopropanol, benzene, hexane, carbon tetrachloride, toluene, diethyl ether, THF, DCM, chloroform, and the like, and/or a mixture thereof. In a preferred embodiment, the washing of the solid may be done by using DCM, followed by water, followed by methanol, followed by THE, and followed by acetone for about 10 minutes each with an amount of about 30 mL of each solvent. The drying of the solid may be done by using heating appliances such as ovens, vacuum ovens, microwaves, autoclaves, hot plates, heating mantles and tapes, oil baths, salt baths, sand baths, air baths, hot-tube furnaces, and hot-air guns. In a preferred embodiment, the drying is done in a vacuum oven.

At step 58, the method 50 includes refluxing the solid with an alcohol. Suitable examples of alcohol include methanol, ethanol, propanol, isopropanol, butanol, pentanol, hexanol, and the like, and/or mixtures thereof. In a preferred embodiment, the refluxing of the solid is done with methanol.

At step 60, the method 50 includes drying the solid at 100-120° C., preferably 102-118° C., more preferably 105-115° C., and yet more preferably 107-112° C. for 18-30 h, preferably 19-29 h, preferably 20-28 h, preferably 21-27 h, more preferably 22-26 h, and yet more preferably 23-25 h, to form the polymer. In a preferred embodiment, the method includes drying the solid at about 110° C. in a vacuum oven for about 24 h. In alternate embodiments, the drying of the solid may be done by using heating appliances such as ovens, vacuum ovens, microwaves, autoclaves, hot plates, heating mantles and tapes, oil baths, salt baths, sand baths, air baths, hot-tube furnaces, and hot-air guns.

### EXAMPLES

The following examples demonstrate a 3D-triptycene-based microporous polymer with hydroxyl groups (TBPP-OH) for carbon dioxide (CO₂) capture. The examples are provided solely for illustration and are not to be construed as limitations of the present disclosure, as many variations thereof are possible without departing from the spirit and scope of the present disclosure.

### Example 1: Materials

Triptycene, resorcinol, dimethoxymethane, and anhydrous iron chloride (FeCl₃) were purchased from Sigma-Aldrich. Anhydrous dichloromethane (DCM), used as a solvent, was also procured from Sigma-Aldrich and used as received.

### Example 2: Synthesis of 3D-Triptycene Containing Microporous Polymer (TBPP-OH)

Triptycene (254 mg, 1 mmol), resorcinol (110 mg, 1 mmol), dimethoxymethane (3 mmol), and FeCl₃ (648 mg, 4 mmol) were taken in a three-necked round bottom flask (100 mL) and subsequently, anhydrous dichloromethane DCM (30 mL) was added and refluxed for 24 hours (h) at constant stirring under a nitrogen atmosphere. The residual solid collected by filtration using a glass frit was subsequently washed with DCM, water, methanol, tetrahydrofuran (THF), and acetone (washing time 10 minutes with 30 mL of each solvent). The solid powder obtained was further washed with refluxing methanol and subjected to a vacuum oven drying at 110° C. for 24 h to yield TBPP-OH (brown-colored solid) as the desired polymer. Yield: 595 mg, 91%; FTIR: 3446 (broad, —OH), 3012, 2926 (—CH—), 1615, 1467 (Ar—, C═C—), 1378, 1262, 1223, 1183, 1097, 891, 822, 765 cm⁻¹.

### Example 3: Structural Characterizations

Fourier-transform infrared (FTIR) spectroscopy analyses were performed to investigate the presence of various functional groups in TBPP-OH using a Nicolet 6700 (Thermo Fisher Scientific, USA) FTIR instrument. Rigaku Miniflex-II diffractometer fitted with a Cu-Kα anode (λ=0.15416 nm) instrument was used to collect the powder XRD data. Solid-state ¹³C Cross-Polarization Magic-Angle-Spinning nuclear magnetic resonance (¹³C CP-MAS NMR) analysis was performed on a Bruker 400 MHz instrument, functioning at 125.65 MHz at room temperature. Thermogravimetric analysis (TGA) was done using a TA Q500 instrument under N₂ flow (100 mL min⁻¹) at a heating rate of 10° C. min⁻¹. The morphological properties of TBPP-OH were examined using high-resolution field-emission scanning electron microscopy (FESEM) on a TESCAN-LYRA-3 (Czech Republic) instrument.

### Example 4: Gas Adsorption Experiment

Unary CO₂, CH₄, and N₂ isotherms were measured at different temperatures using the

Quadrasorb SI instrument (Quantachrome Instruments, US). Prior to the isotherm measurements, approximately 200 mg of the samples were pre-treated at 130° C. under a dynamic vacuum (10-5 bar) for 12 h. The isotherm temperatures were maintained within the accuracy of ±1° C. using a circulation bath containing a 1:1 mixture of water and ethylene glycol. The adsorption mechanism was elucidated by fitting the experimental data points with the Langmuir and dual-site Langmuir model equation 1 and equation 2 (Eq. 1 and Eq. 2), respectively [K. Y. Foo, B. H. Hameed, Insights into the modeling of adsorption isotherm systems, Chemical Engineering Journal. 156 (2010).; and A. Hanif, S. Dasgupta, A. Nanoti, Facile Synthesis of High-Surface-Area Mesoporous MgO with Excellent High-Temperature CO₂ Adsorption Potential, Ind Eng Chem Res. 55 (2016), both of which are incorporated herein by reference in their entireties]:

$${n}^{*} = \frac{{m}_{1} {k}_{1} P}{1 + {k}_{1} P} \qquad ( 1 )$$

$${n}^{*} = \frac{{m}_{1} {k}_{1} P}{1 + {k}_{1} P} + \frac{{m}_{2} {k}_{2} P}{1 + {k}_{2} P} \qquad ( 2 )$$

where n* is the predicted capacity (mmol/g), k₁ and k₂ are equilibrium constants (bar⁻¹) for sites of type 1 and type 2, respectively, and P is the pressure (bar). Eq. 1 and Eq. 2 were used to determine CO₂ uptake, N₂ uptake, and CH₄ uptake.

Further, these isotherm results were used to calculate the LAST selectivity for representative post-combustion flue gas (15% CO₂ and 85% N₂) and biogas mixtures (50% CO₂ and 50% CH₄) mixtures using Eq. 3 [N. Singh, S. Dalakoti, H. N. Wamba, R. Chauhan, S. Divekar, S. Dasgupta, Aarti, Preparation of Cu-BTC MOF extrudates for CH₄ separation from CH₄/N₂ gas mixture, Microporous and Mesoporous Materials. 360 (2023), which is incorporated herein by reference in its entirety]:

$${S}_{1 / 2} = \frac{{n}_{1}}{{n}_{2}} * \frac{{p}_{2}}{{p}_{1}} \qquad ( 3 )$$

where n₁ and n₂ are adsorption capacities (mmol/g) of component 1 and component 2 at p₁ and p₂, which represent the partial pressures of component 1 and component 2 in feed gas, respectively.

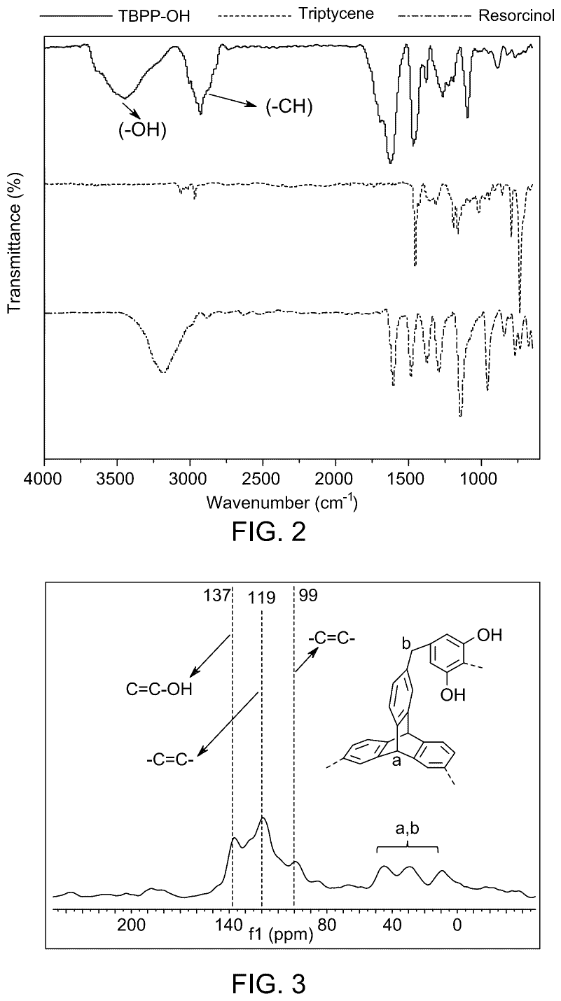

The polymer TBPP-OH was synthesized by a facile one-pot Friedel-Crafts crosslinking polymerization reaction using triptycene and resorcinol as monomers, as depicted in FIG. 1B. The polymer TBPP-OH is a brown-colored solid and was found to be insoluble in most of the common organic solvents like dichloromethane, tetrahydrofuran, dimethylformamide, and dimethyl sulfoxide. Structural characterizations of TBPP-OH were performed using a ¹³C CP-MAS NMR and ATR-FTIR spectroscopy to confirm the successful synthesis of a microporous polymer and the high conversion of the available cross-linker. FIG. 2 shows Fourier-transform infrared (FTIR) spectrum of the TBPP-OH, triptycene, and resorcinol. In the FTIR spectra of TBPP-OH, the broad peak at about 3446 cm⁻¹ is due to the presence of hydroxyl groups in the polymer. Additionally, the peak observed at 2926 cm⁻¹ corresponds to the characteristics of —CH— stretching vibration of the aliphatic —CH₂— groups indicating successful crosslinking. The appearance of two different aromatics —C═C— stretching vibrations at 1615 and 1467 cm⁻¹ is attributed to the incorporations of both aromatic monomers in the polymeric framework of TBPP-OH.

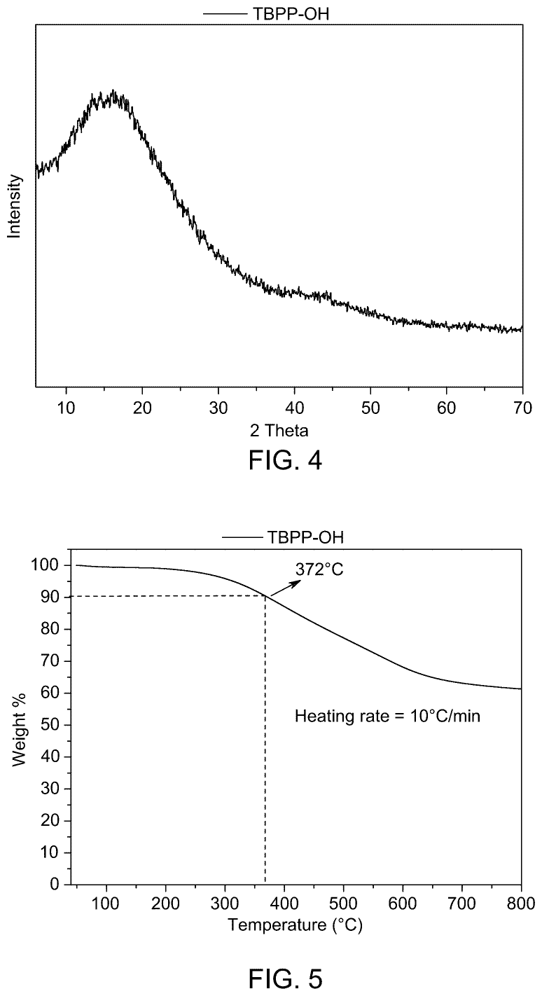

The ¹³C CP-MAS NMR spectrum of TBPP-OH is shown in FIG. 3. The broad peaks in the region of 140-99 ppm were attributed to the aromatic carbons of the polymeric framework. The peak at 137 ppm was assigned to hydroxyl-substituted aromatic carbon (C—C—OH). The peaks due to bridgehead carbon of triptycene (—CH—) motifs and methylene carbons (—CH₂—) appeared at about 50-15 ppm. The ¹³C CP-MAS NMR analysis revealed the successful incorporation of 3D-triptycene motifs and resorcinol units in the polymeric framework of TBPP-OH.

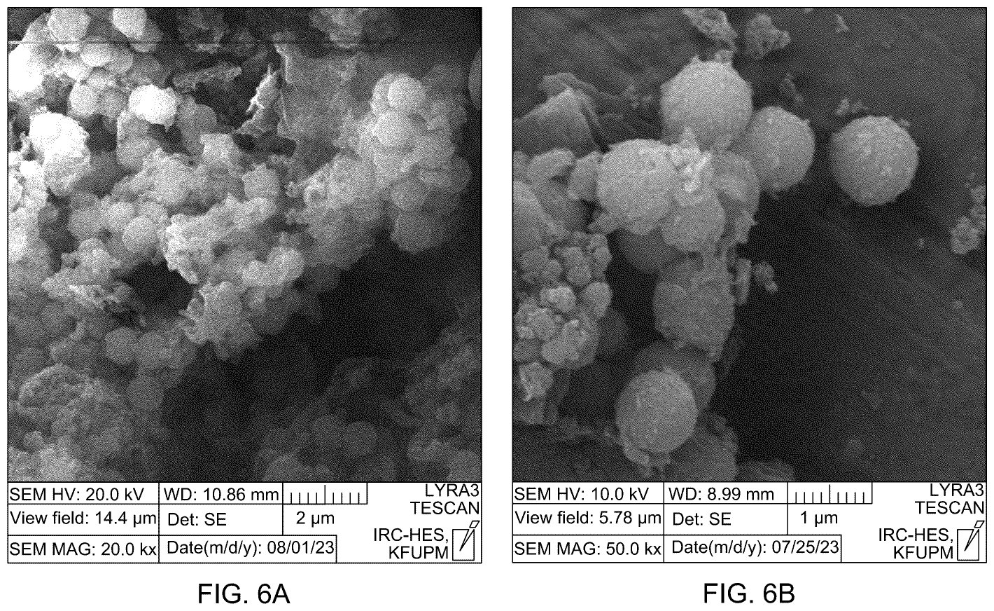

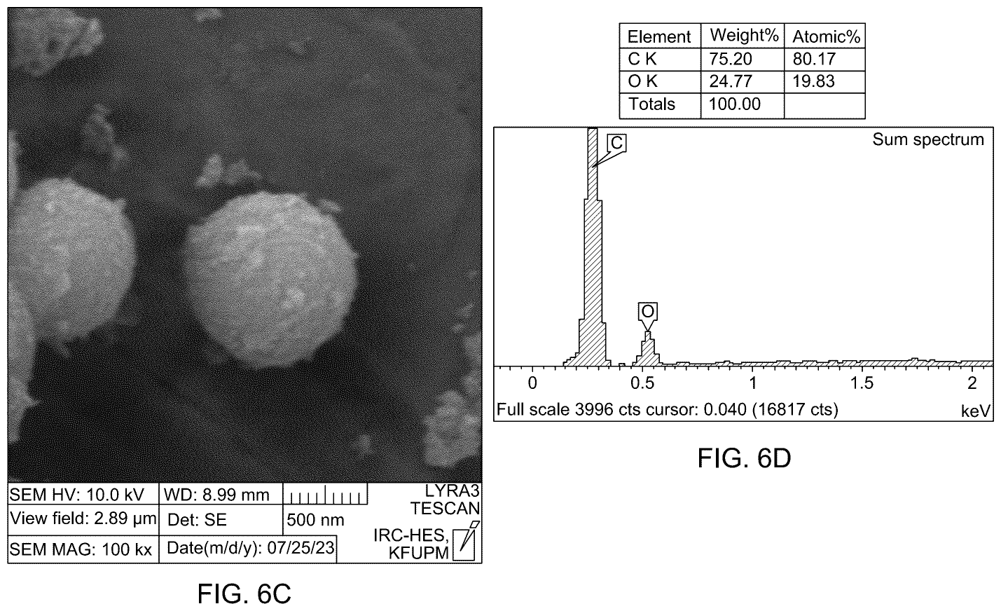

Powder X-ray diffraction (PXRD) analysis of TBPP-OH shows a broad spectrum (FIG. 4), exhibiting its amorphous nature, which may be attributed to the existence of rigid, robust, and bulky 3D-triptycene motif in the polymeric framework of TBPP-OH. The thermal stability of TBPP-OH was determined by carrying out thermogravimetric analysis (TGA), as shown in FIG. 5. A measured TBPP-OH sample was heated to 800° C. under a nitrogen environment at a heating rate of 10° C./minute. The thermal degradation temperature (T_{d}) for TBPP-OH was 372° C., at which only a 10% weight loss was noticed. The char yield at 800° C. was observed to be 61%. The TGA analysis indicates that TBPP-OH has a high heat resistance and is a thermally stable material suitable for various applications. The high thermal stability exhibited by TBPP-OH may be attributed to the presence of rigid and robust 3D-triptycene units in the polymeric network.

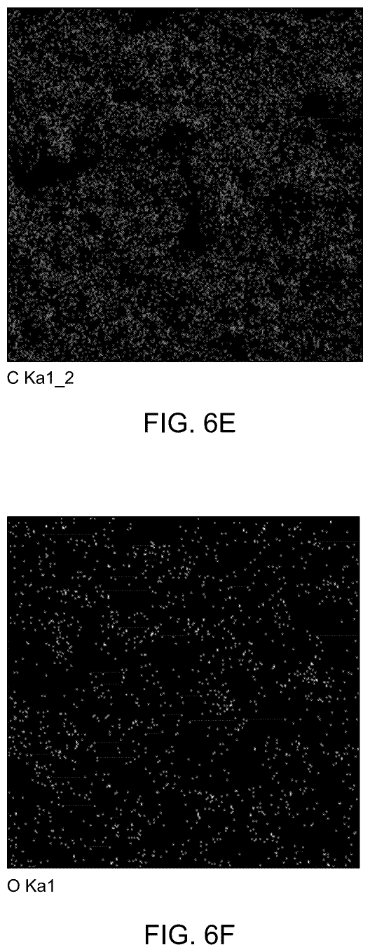

Field-emission scanning electron microscopy (FESEM) analysis was carried out to further study the morphology of TBPP-OH. FIGS. 6A-6C shows the FESEM images of TBPP-OH at various magnifications. The porous polymers are in the form of spherical aggregates with diameters ranging from 0.5 to 1 μm. FIG. 6D is an energy-dispersive X-ray spectroscopy (EDS) spectra of the TBPP-OH. FIGS. 6E-6F shows an EDS-elemental mapping image of the TBPP-OH showing carbon (C) and oxygen (O), respectively. The scanning electron microscopy energy-dispersive X-ray spectroscopy (SEM-EDS) mapping of the polymer sample shows that TBPP-OH contains a high O content of around 24%, which indicates the presence of abundant hydroxyl groups. Additionally, this also demonstrates that resorcinol was successfully incorporated into the polymeric network of TBPP-OH.

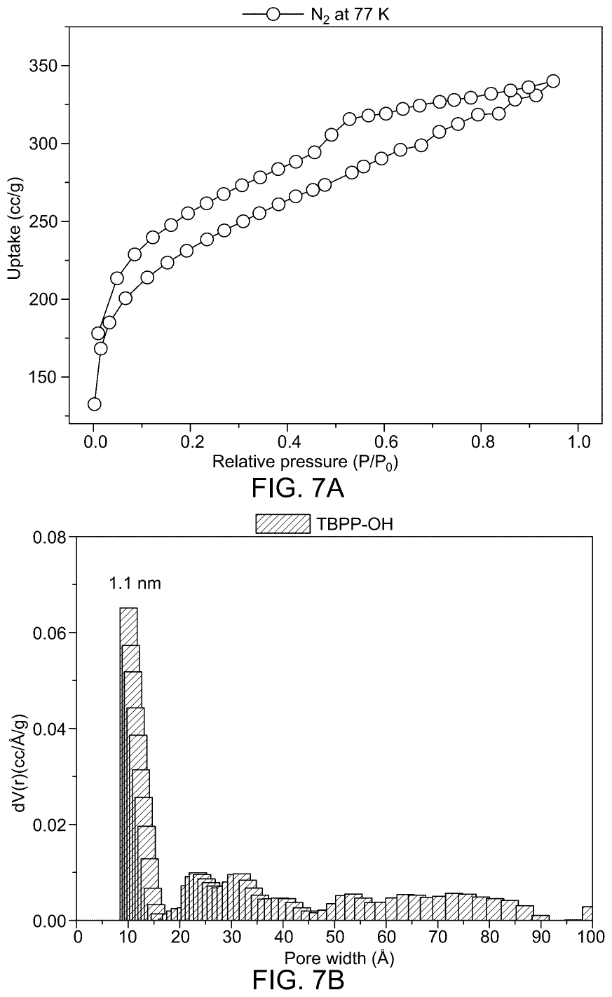

The N₂ adsorption-desorption isotherms at 77 kelvin (K) and 1 bar pressure were used to explore the textural features such as porosity, surface area, and pore volumes. FIG. 7A shows that TBPP-OH demonstrated a type I sorption isotherm, indicating its microporous nature. Furthermore, TBPP-OH showed rapid N₂ uptake at very low pressures (P/P₀=0-0.01), while at high pressures, the isotherms increase gradually. This shows that most of the pores in TBPP-OH are micropores, along with some mesopores. The pore size distribution plot obtained from the N₂ sorption isotherm using the Density Functional Theory (DFT) further supports that TBPP-OH is microporous (% V_{mic}=70%) with most of the pores in the region of 1.1 nm, as shown in FIG. 7B. The microporous nature of TBPP-OH may be attributed to the presence of 3D-triptycene motifs with internal free volumes (IFV) and extensive crosslinking in the polymeric network. TBPP-OH exhibited a high BET-specific surface area (SABET) of 838 square meters per gram (m² g⁻¹) with a total pore volume of 0.491 cubic centimeters per gram (cm³ g⁻¹) and a micropore volume of 0.346 cm³ g⁻¹.

TABLE 1
Porous property, gas capture, and selectivity
of TBPP-OH at different temperatures.

| Material | TBPP-OH |
|---|---|
| BET surface area (m² g⁻¹) | 838 |
| Total pore volume (Vₜₒₜ) (cm³ g⁻¹) | 0.491 |
| Micropore volume (V_{mic}) (cm³ g⁻¹) | 0.346 |
| CO₂ uptake at 1 bar (mg g⁻¹) at 273 K | 122 |
| CO₂ uptake at 1 bar (mg g⁻¹) at 298 K | 77 |
| CO₂ uptake at 1 bar (mg g⁻¹) at 313 K | 56 |
| CH₄ uptake at 1 bar (mg g⁻¹) 273 K | 12 |
| CH₄ uptake at 1 bar (mg g⁻¹) 298 K | 8 |
| CO₂ isosteric heat of adsorption (Qₛₜ) (kJ/mol) | 32.9 |
| Selectivity CO₂/N₂ at 273 K | 37 |
| Selectivity CO₂/N₂ at 298 K | 18 |
| Selectivity CO₂/CH₄ at 273 K | 4.2 |
| Selectivity CO₂/CH₄ at 298 K | 4.1 |

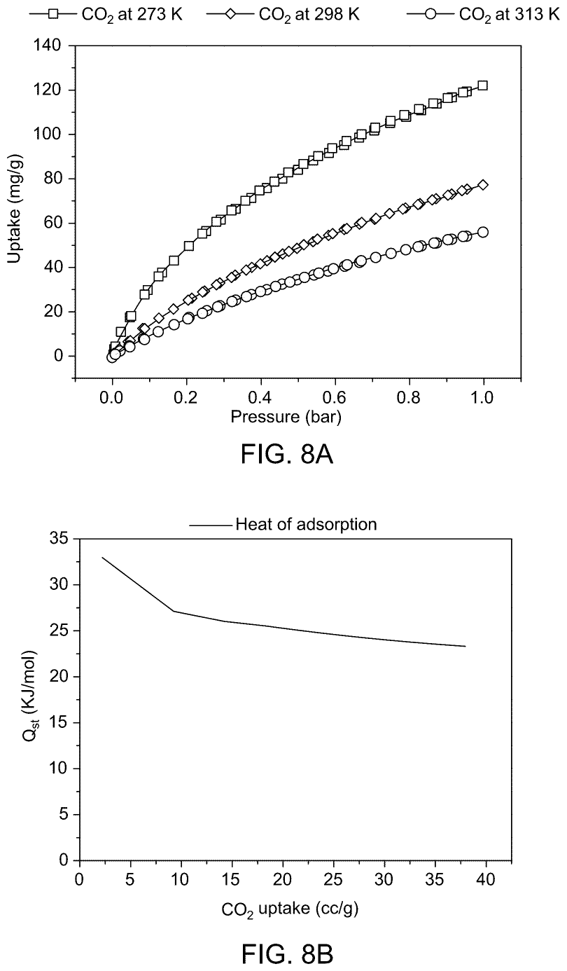

To assess the CO₂-adsorption property of TBPP-OH, CO₂ adsorption-desorption isotherms were performed at various temperatures, as presented in FIG. 8A. The presence of numerous CO₂-philic hydroxyl groups and a microporosity with a large surface area in TBPP-OH demonstrated capability for CO₂ adsorption. FIG. 8B is a graph showing the heat of adsorption for the TBPP-OH for CO₂ uptake. The hysteresis-free features of the CO₂ adsorption-desorption isotherms demonstrate the reversible CO₂ uptake capability of TBPP-OH. The CO₂ capture capacities of TBPP-OH are 122, 77, and 56 milligrams per gram (mg g⁻¹) at 273, 298, and 313 K, respectively, at a pressure of 1 bar, as shown in Table 1. The CO₂ capture efficiency at 273 K and 298 K demonstrated by TBPP-OH is comparatively better than previously reported porous polymers for CO₂ capture, as seen in Table 2. The CO₂ uptake values exhibited by TBPP-OH may be attributed to its highly microporous network formed by 3D triptycene and the presence of CO₂-philic —OH groups. Heat of adsorption, Qₛₜ, was also measured from the corresponding CO₂ adsorption isotherms of TBPP-OH to get an insight into the CO₂ trapping mechanism. The magnitude of isosteric heat of adsorption (Qₛₜ) was observed to be 32.9 kilojoules per mole (kJ mol⁻¹), which suggests that the CO₂ adsorption by TBPP-OH is through a physisorption process.

TABLE 2
Comparison of CO₂ uptake capacity of TBPP-OH
with other reported porous polymers.

| | CO₂ | CO₂ | | | | |
|---|---|---|---|---|---|---|
| | uptake | uptake | CO₂ isosteric heat | Selectivity | Selectivity | |
| | at 1 bar | at 1 bar | of adsorption | CO₂/N₂ | CO₂/CH₄ | |
| | (mg/g) | (mg/g) | (Qₛₜ) | 273K | 273K | |
| Material | 273K | 298K | (kJ/mol) | (298K) | (298K) | Ref. |
| TBPP-OH | 122 | 77 | 32.9 | 37 (18) | 4.2 (4.1) | This |
| | | | | | | work |
| HCP1b | 36.1 | 23.5 | 38.2 | 32.8 | — | 1 |
| An-CPOP-1 | 61.5 | 57.1 | — | — | — | 2 |
| AF-32 | 73 | 40 | 26 | — | — | 3 |
| HCP-BA | 84.6 | — | 27.4 | 28 (19) | — | 4 |
| HPIL-Cl-2 | 79 | 44 | 45 | 37 | — | 5 |
| PCP-Cl | 101.7 | 61.4 | 28.5 | 42 (34) | — | 6 |
| HCP-B | 64.2 | 55.4 | — | — | — | 7 |
| CB-PCP-1 | 90 | 53 | 35 | — | — | 8 |
| TBP-1 | 51 | 35 | 33.7 | — | — | 9 |
| STNP3 | 86 | 50 | 22 | — | — | 10 |
| HMP-3 | 104 | 47 | — | — | — | 11 |
| HPP-3 | 61 | 29.9 | 35 | — | — | 12 |

[1] L. Shao, N. Liu, L. Wang, Y. Sang, H. Wan, P. Zhan, L. Zhang, J. Huang, J. Chen, Facile preparation of oxygen-rich porous polymer microspheres from lignin-derived phenols for selective CO₂ adsorption and iodine vapor capture, Chemosphere. 288 (2022);
[2] M. G. Mohamed, X. Zhang, T. H. Mansoure, A. F. M. El-Mahdy, C. -F. Huang, M. Danko, Z. Xin, S. -W. Kuo, Hypercrosslinked porous organic polymers based on tetraphenylanthraquinone for CO₂ uptake and high-performance supercapacitor, Polymer (Guildf). 205 (2020) 122857;
[3] X. Jing, D. Zou, P. Cui, H. Ren, G. Zhu, Facile synthesis of cost-effective porous aromatic materials with enhanced carbon dioxide uptake, J Mater Chem A Mater. 1 (2013);
[4] Y. Luo, S. Zhang, Y. Ma, W. Wang, B. Tan, Microporous organic polymers synthesized by self-condensation of aromatic hydroxylmethyl monomers, Polym Chem. 4 (2013);
[5] Y. Sang, J. Huang, Benzimidazole-based hyper-cross-linked polyionic liquids for efficient CO₂ capture and conversion, Chemical Engineering Journal. 385 (2020);
[6] O. Buyukcakir, S. H. Je, D. S. Choi, S. N. Talapaneni, Y. Seo, Y. Jung, K. Polychronopoulou, A. Coskun, Porous cationic polymers: The impact of counteranions and charges an CO₂ capture and conversion, Chemical Communications. 52 (2016);
[7] J. Huang, J. Zhu, S. A. Snyder, A. J. Morris, S. R. Turner, Nanoporous highly crosslinked polymer networks with covalently bonded amines for CO₂ capture, Polymer (Guildf). 154 (2018);
[8] A. Dani, V. Crocella, C. Magistris, V. Santoro, J. Yuan, S. Bordiga, Click-based porous cationic polymers for enhanced carbon dioxide capture, J Mater Chem A Mater. 5 (2017);
[9] R. Bera, S. Mondal, N. Das, Nanoporous triptycene based network polyamides (TBPs) for selective CO₂ uptake, Polymer (Guildf). 111 (2017);
[10] A. Alam, A. Hassan, R. Bera, N. Das, Silsesquioxane-based and triptycene-linked nanoporous polymers (STNPs) with a high surface area for CO₂ uptake and efficient dye removal applications, Mater Adv. 1 (2020) 3406-3416;
[11] A. Zhang, H. Gao, W. Li, H. Bai, S. Wu, Y. Zeng, W. Cui, X. Zhou, L. Li, Hybrid microporous polymers from double-decker-shaped silsesquioxane building blocks via Friedel-Crafts reaction, Polymer (Guildf). 101 (2016); and
[12] D. Wang, W. Yang, S. Feng, H. Liu, Constructing hybrid porous polymers from cubic octavinylsilsequioxane and planar halogenated benzene, Polym Chem. 5 (2014), each of which are incorporated herein by references in their entireties.

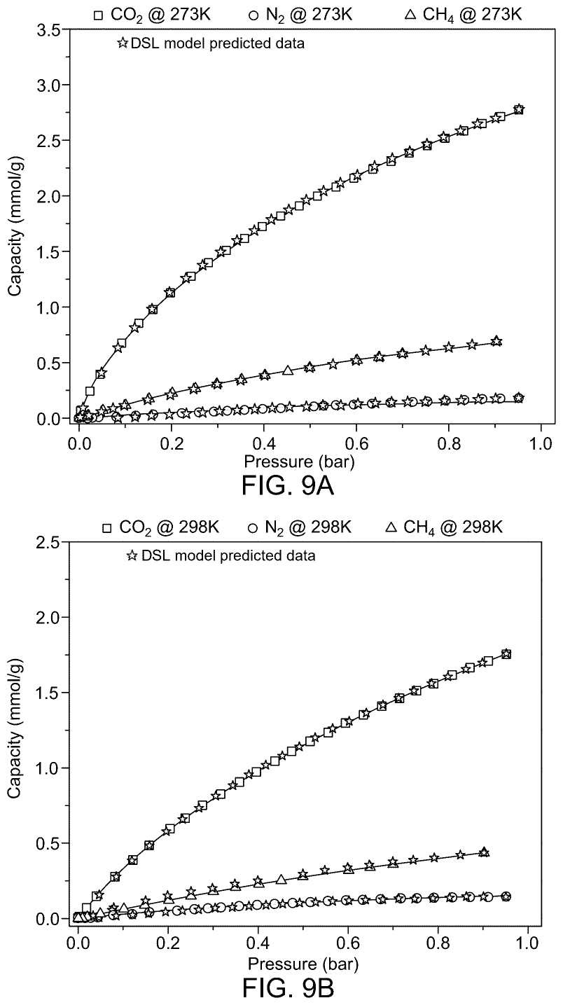

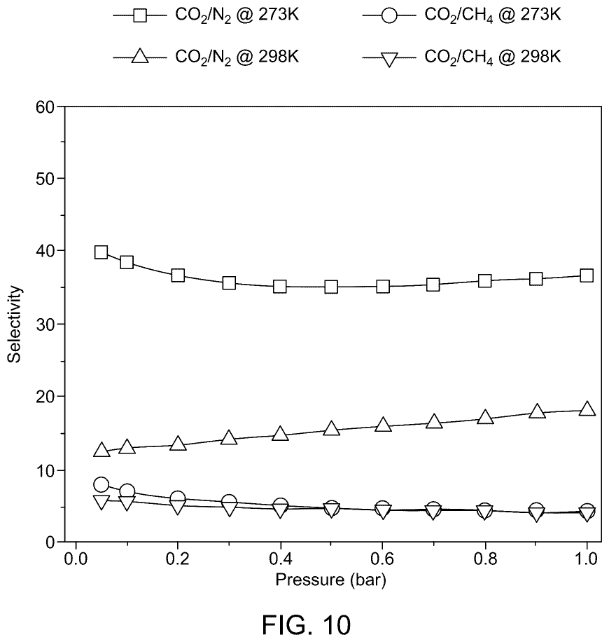

After the successful CO₂ capture performance of TBPP-OH, the CO₂/N₂ and CO₂/CH₄ selectivity of TBPP-OH at different temperatures was gauged. CO₂/N₂ separation is a component of post-combustion CO₂ capture from flue gases, which typically include >70% N₂ and around 15% CO₂. Further, separating CO₂ from CH₄ for the treatment of CH₄-rich gases, including landfill gases, which are often equimolar combinations of CO₂ and CH₄, is of interest; therefore, TBPP-OH's capability for the separation of landfill gas containing a CO₂/CH₄ mixture (50/50, v/v) and flue gas containing a CO₂/N₂ mixture (15/85, v/v) was assessed. FIGS. 9A-9B show CO₂, methane (CH₄), and nitrogen (N₂) isotherms of TBPP-OH at 273 K and 298 K, respectively. TBPP-OH exhibited a higher efficiency in capturing CO₂ over N₂ and CH₄. As a result, higher uptake of CO₂ was observed compared to N₂ and CH₄ in the two adsorption isotherms at 273 and 298 K temperatures. Further, the CO₂/N₂, and CO₂/CH₄ selectivity values were measured by utilizing the ideal adsorbed solution theory (IAST) method, which is a widely used method for predicting the selectivity for gas mixture separation from experimental single-component isotherms of adsorption under given conditions. FIG. 10 shows IAST selectivity curves for 15% CO₂:85% N₂ and 50% CO₂:50% CH₄ compositions. The observed CO₂/N₂ selectivity for TBPP-OH has a value of 37 at 273 K and 1 bar of pressure and is comparable to or higher than other porous polymeric adsorbents, as seen in Table 2. At 298 K, CO₂/N₂ selectivity for TBPP-OH was estimated to be 18.

Further adsorption mechanisms were elucidated by fitting the experimental adsorption-desorption data points with the Langmuir model and the dual-site Langmuir model. The experimental data can be predicted more appropriately using the dual-site Langmuir model, giving an indication of two types of adsorption sites in the adsorbent. The adsorption and desorption isotherms are overlapping for all gases, indicating weak physisorption-type interactions and the possibility of adsorbent regeneration by a simple pressure/vacuum swing. Further, at both investigated temperatures, CO2 adsorption capacity is the highest, followed by CH₄, and N₂. This is attributed to the highest polarizability (2.507 Å₃ for CO₂ vs 2.448 Å³ for CH₄, and 1.710 Å³ for N₂) and quadrupole moment (4.30 DÅ for CO₂ vs 1.54 DÅ and 0.02 DÅ for N₂ and CH₄, respectively) for CO₂ among the three gases, which favors stronger physisorption interactions of CO₂ than the other two adsorbents. Further, CO₂ is a weakly acidic gas and may interact with the basic —OH groups of the TBPP-OH through weak acid-base interactions. Even though N₂ has a larger quadrupole moment than CH₄, CH₄ has a higher polarizability than N₂, favoring CH₄ adsorption over N₂.

Adsorption for the gases decrease with temperature, indicating the presence of weak physisorption interactions between the adsorbent and adsorbate. The CO₂/N₂ and CO₂/CH₄ selectivity curves of the adsorbent for feed gas simulating post-combustion CO₂ capture and biogas upgrading are given in FIG. 10. At a given temperature, the CO₂/N₂ selectivity is higher than that of CO₂/CH₄ selectivity, as CO₂ and N₂ show a greater difference in polarizability as compared to CO₂/CH₄. Further, the selectivity decreases with increasing temperature for both CO₂/N₂ and CO₂/CH₄ separation, indicating that the adsorbent shows both better capacity and selectivity at 273 K.

The design, synthesis, and characterization of a triptycene-based microporous polymer decorated with —OH functional groups (TBPP-OH) was used for carbon dioxide capture. The incorporation of 3D-triptycene motifs in the polymeric framework of TBPP-OH provides desirable properties such as microporosity, high surface area, and thermal stability. These structural features make TBPP-OH a potential material for efficient and selective CO² uptake. TBPP-OH demonstrated a high CO² uptake of 122 mg g⁻¹ at 273 K. The CO₂/N₂ selectivity values were also good; therefore, TBPP-OH may be considered a potentially useful material for environmental remediation applications due to its facile synthesis and capacity to efficiently and selectively capture CO₂ over N₂ and CH₄.

Numerous modifications and variations of the present disclosure are possible in light of the above teachings. It is therefore to be understood that within the scope of the appended claims, the invention may be practiced otherwise than as specifically described herein.

1. A microporous polymer, including:
reacted units of a triptycene, a secondary carbon linker, and a dihydroxy phenol,
wherein the microporous polymer is in the form of porous particles,
wherein the reacted units of the triptycene are covalently bonded to the dihydroxy phenol by the secondary carbon linker.

2. A method for capturing CO₂, comprising:
contacting a CO₂-containing gas stream with the porous particles of the microporous polymer of claim 1 to trap molecules of CO₂ in the CO₂-containing gas stream in the molecular structure of the microporous polymer,
wherein the microporous polymer includes reacted units of triptycene, reacted units of dimethoxymethane, and resorcinol.

3. The microporous polymer of claim 1, wherein the microporous polymer contains oxygen in an amount 20 to 30 atomic percent (at. %) based on a total atom count of the microporous polymer.

4. The microporous polymer of claim 1, wherein the microporous polymer has a thermal degradation temperature of 350 to 400 degrees Celsius (° C.), wherein the thermal degradation temperature is determined at a weight loss of 10 wt. % based on an initial weight of the microporous polymer.

5. The microporous polymer of claim 1, wherein the microporous polymer has a char yield at 800° C. of 55 to 65 wt. % based on an initial weight of the microporous polymer.

6. The microporous polymer of claim 1, wherein the porous particles are in the form of spheres with a diameter of 0.2 to 2 micrometers (μm).

7. The microporous polymer of claim 6, wherein the spheres are aggregated.

8. The microporous polymer of claim 1, wherein the porous particles have a Brunauer-Emmett-Teller surface area of 800 to 850 square meters per gram (m² g⁻¹).

9. The microporous polymer of claim 1, wherein the porous particles have a total pore volume of 0.400 to 0.600 cubic centimeters per gram (cm³ g⁻¹).

10. The microporous polymer of claim 1, wherein the porous particles have a micropore volume of 0.300 to 0.400 cm³ g⁻¹.

11. The microporous polymer of claim 1, wherein porous particles have a micropore volume of 65 to 75 percent (%).

12. The microporous polymer of claim 1, wherein the microporous polymer has a carbon dioxide (CO₂) isosteric heat of adsorption (Qₛₜ) of 30 to 35 kilojoules per mole (kJ mol⁻¹).

13. The microporous polymer of claim 1, wherein the microporous polymer has a CO² uptake of 120 to 125 milligrams per gram (mg g⁻¹) at a pressure of 1 bar and a temperature of 273 kelvin (K).

14. The microporous polymer of claim 1, wherein the microporous polymer has a CO² uptake of 75 to 80 mg g-1 at a pressure of 1 bar and a temperature of 298 K.

15. The microporous polymer of claim 1, wherein the microporous polymer has a CO² uptake of 50 to 60 mg g⁻¹ at a pressure of 1 bar and a temperature of 313 K.

16. The microporous polymer of claim 1, wherein microporous polymer has a methane (CH₄) uptake of 10 to 15 mg g⁻¹ at a pressure of 1 bar and a temperature of 273 K.

17. The microporous polymer of claim 1, wherein microporous polymer has a CH₄ uptake of 5 to 10 mg g⁻¹ at a pressure of 1 bar and a temperature of 298 K.

18. The microporous polymer of claim 1, wherein the microporous polymer has a selectivity of CO₂/N₂ from 35 to 40 at a temperature of 273 K.

19. The microporous polymer of claim 1, wherein the microporous polymer has a selectivity of CO₂/CH₂ from 3 to 5 at a temperature of 273 K.

20. The microporous polymer of claim 1, wherein the microporous polymer is made by a process including:
mixing triptycene, resorcinol, dimethoxymethane, and an iron salt in an organic solvent to form a solution,
wherein a molar ratio of the triptycene to the resorcinol is 1:2 to 2:1,
wherein a molar ratio of the triptycene to the dimethoxymethane is 1:1 to 1:5,
wherein a molar ratio of the triptycene to the iron salt is 1:2 to 1:6,
refluxing the solution for 18 to 30 hours (h) to form a solid;
washing and drying the solid;
refluxing the solid with an alcohol; and
drying the solid at 100 to 120° C. for 18 to 30 h to form the polymer.
